(19) United States
(12) Patent Application Publication
(10) Pub. No.: US 2012/0166211 A1
(43) Pub. Date: Jun. 28, 2012

(54) METHOD AND APPARATUS FOR AIDING IMAGING DIAGNOSIS USING MEDICAL IMAGE, AND IMAGE DIAGNOSIS AIDING SYSTEM FOR PERFORMING THE METHOD

(75) Inventors: Jin-man Park, Yongin-si (KR); Kyoung-gu Woo, Seoul (KR)

(73) Assignee: SAMSUNG ELECTRONICS CO., LTD., Suwon-si (KR)

(21) Appl. No.: 13/193,085

(22) Filed: Jul. 28, 2011

(30) Foreign Application Priority Data
Dec. 24, 2010 (KR) 10-2010-0134909

(51) Int. Cl. G06Q 50/00

(52) U.S. Cl. 705/2

(57) ABSTRACT

A method of aiding an imaging diagnosis is provided. The method includes receiving a medical image and a current electronic medical record (EMR) of a patient, acquiring image analysis profiles used in a plurality of different image analysis modes from EMRs corresponding to the received current EMR among EMRs stored in an EMR database, analyzing the received medical image according to each of the image analysis modes by using the acquired image analysis profiles, and generating a plurality of diagnostic images respectively corresponding to the image analysis modes on the basis of the analyzed medical image.

### CROSS-REFERENCE TO RELATED APPLICATIONS

This application claims the benefit of Korean Patent Application No. 10-2010-0134909, filed on Dec. 24, 2010, in the Korean Intellectual Property Office, the entire disclosure of which is incorporated herein by reference for all purposes.

### BACKGROUND

1. Field

The following description relates to a method and apparatus for aiding imaging diagnosis using a medical image, and an image diagnosis aiding system for performing the method.

2. Description of the Related Art

An image diagnosis aiding system is widely used to diagnose a disease, create a treatment plan, or evaluate treatment progress on the basis of a medical image in a medical institution. A doctor is capable of observing a condition of a lesion or a change of a lesion by analyzing a patient's medical image produced by a monitor of the image diagnosis aiding system. However, reading of a medical image may involve significant measurement errors because a medical image is read manually and interpreted subjectively by a doctor and different doctors may have differing opinions and reach different conclusions about the same medical image. Moreover, a doctor may occasionally fail to identify a lesion present in a medical image. Accordingly, a computer aided diagnosis system that primarily reads a medical image through a computer aided diagnosis (CAD) and provides a doctor with information regarding an existence of a lesion, a location of a lesion, and the like has recently been developed. A computer aided diagnosis system 1) identifies a lesion in a medical image by processing information regarding a presence of an abnormality, a size of an abnormality, a location of an abnormality, or the like using a computer and 2) gives a doctor a result of the identification, thereby aiding the doctor in an imaging diagnosis of the lesion.

### SUMMARY

The following description relates to methods and apparatuses for aiding an imaging diagnosis using a medical image, and an imaging diagnosis aiding system for performing the method.

In one general aspect, a method of aiding an imaging diagnosis is provided. The method includes receiving a medical image and a current electronic medical record (EMR) of a patient, acquiring image analysis profiles used in a plurality of different image analysis modes from EMRs corresponding to the received current EMR among EMRs stored in an EMR database, analyzing the received medical image according to each of the image analysis modes by using the acquired image analysis profiles, and generating a plurality of diagnostic images respectively corresponding to the image analysis modes on the basis of the analyzed medical image.

The corresponding EMRs may be EMRs coinciding with filtering rules of the image analysis modes among EMRs of the patient and of another patient.

The filtering rule may include at least one selected from a group including a rule that filters a past EMR of the patient, a rule that filters an EMR of a group having a field similar to at least one of fields of the received current EMR, and a rule that filters an EMR having a similarity falling within a predetermined range with respect to the received current EMR.

Controlling display of the generated diagnostic images on a screen may be provided on a user interface unit.

The controlling of the display may include displaying explanations on the image analysis modes respectively corresponding to the displayed diagnostic images.

Updating the current EMR of the patient may be stored in the EMR database with information regarding a diagnostic image determined to provide a user with an accurate analysis of the patient among the displayed diagnostic images.

The EMRs stored in the EMR database may be clustered in advance into groups of EMRs having similar fields by a data mining technique, and a search index with respect to a similarity between the EMRs is predefined.

The analyzing of the received medical image may include executing the image analysis modes in parallel.

Before the acquiring of the image analysis profiles, receiving an input selecting at least one image analysis mode may be desired by a user among the image analysis modes from a user interface unit. The acquiring of the image analysis profiles and the analyzing of the received medical image may be performed only for the at least one selected image analysis mode.

The image analysis profiles may include information regarding an image processing technique, information regarding a lesion segmentation technique, and information regarding a lesion classification technique.

The medical image may be an ultrasound image of a part of the patient's body.

A non-transitory computer-readable storage medium may store a program for executing the method in a computer.

The received medical image may be an image captured by an X-ray machine or an ultrasound machine.

In one general aspect, an apparatus for aiding an imaging diagnosis may be provided. The apparatus includes a data reception unit configured to receive a medical image and a current electronic medical record (EMR) of a patient, an EMR acquisition unit configured to acquire image analysis profiles used in a plurality of different image analysis modes from EMRs corresponding to the received current EMR among EMRs stored in an EMR database, an image analysis unit configured to analyze the received medical image according to each of the image analysis modes by using the acquired image acquisition profiles, and a diagnostic image generation unit configured to generate a plurality of diagnostic images respectively corresponding to the image analysis modes on the basis of the analyzed medical image.

The corresponding EMRs may be EMRs coinciding with filtering rules of the image analysis modes among EMRs of the patient and of another patient.

The filtering rule may include at least one selected from the group consisting of a rule that filters a past EMR of the patient, a rule that filters an EMR of a group having a field similar to at least one of fields of the received current EMR, and a rule that filters an EMR having a similarity falling within a predetermined range with respect to the received current EMR.

A display control unit may be configured to control display of the generated diagnostic images on a screen provided on a user interface unit connected to the apparatus for aiding an imaging diagnosis.

The EMRs stored in the EMR database may be clustered in advance into groups of EMRs having similar fields by a data mining technique, and a search index with respect to a similarity between the EMRs is predefined.

The received medical image may be an image captured by an X-ray machine or an ultrasound machine.

In still another aspect, an imaging diagnosis system is provided. an image capturing unit configured to capture a medical image of a part of a patient's body, an electronic medical record (EMR) database configured to store EMRs of the patient and of another patient, an apparatus for aiding an imaging diagnosis, the apparatus configured to receive the medical image and a current electronic medical record (EMR) of the patient, configured to acquire image analysis profiles used in plurality of different image analysis modes from EMRs corresponding to the received current EMR among the EMRs stored in the EMR database, configured to analyze the received medical image according to each of the image analysis modes by using the acquired image acquisition profiles, and configured to generate a plurality of diagnostic images respectively corresponding to the image analysis modes on the basis of the analyzed medical image, and a user interface unit configured to display the generated diagnostic images on a screen of the user interface.

The corresponding EMRs may be EMRs coinciding with filtering rules of the image analysis modes among the EMRs of the patient and of the other patient.

The EMRs may be stored in the EMR database are clustered in advance into groups of EMRs having similar fields by a data mining technique, and a search index with respect to a similarity between the EMRs is predefined.

The received medical image may be an image captured by an X-ray machine or an ultrasound machine.

In still yet another aspect, a method of aiding an imaging diagnosis of a lesion is provided. The method includes receiving a medical image of the lesion and a current electronic medical record (EMR) of a patient, acquiring image analysis profiles used in a plurality of different image analysis modes from EMRs corresponding to the received current EMR among EMRs stored in an EMR database, wherein the EMRs include any of a size, a type and a location of previously measured lesions, analyzing the received medical image according to each of the image analysis modes by using the acquired image analysis profiles based on the any of the size, the type and the location of the previously measured lesions, and generating a plurality of diagnostic images respectively corresponding to the image analysis modes on the basis of the analyzed medical image.

The received medical image may be an image captured by an X-ray machine or an ultrasound machine.

Other features and aspects may be apparent from the following detailed description, the drawings, and the claims.

### BRIEF DESCRIPTION OF THE DRAWINGS

FIG. 1 is a schematic diagram illustrating an imaging diagnosis system according to an example embodiment;

FIG. 2 is a detailed diagram illustrating an apparatus for aiding an imaging diagnosis according to an example embodiment;

FIGS. 3A through 3C are views illustrating a process of acquiring image analysis profiles used in respective image analysis modes according to an example embodiment;

FIG. 4 is a view illustrating a plurality of diagnostic images displayed on a user interface unit according to an example embodiment; and

FIG. 5 is a flowchart illustrating a method of aiding an imaging diagnosis according to an example embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

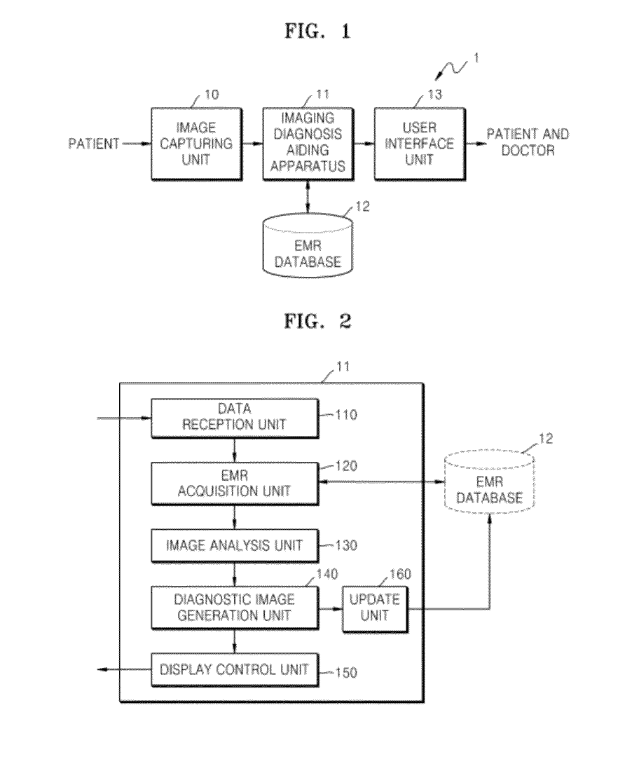

FIG. 1 is a schematic diagram illustrating an imaging diagnosis system 1 according to an example embodiment of the present invention. Referring to FIG. 1, the imaging diagnosis system 1 according to the example embodiment includes an image capturing unit 10, an apparatus 11 for aiding an imaging diagnosis (hereinafter, referred to as ‘an imaging diagnosis aiding apparatus’), an electronic medical record (EMR) database 12, and a user interface unit 13.

Only elements of the imaging diagnosis system 1 that may be associated with the example embodiment are shown in FIG. 1. However, it will be understood by those of ordinary skill in the art that general-use elements may be included.

Referring to FIG. 1, the image capturing unit 10 may capture a medical image of a part of a patient's body. Here, the medical image may be an ultrasound image, an x-ray image, or the like. Thus, the imaging diagnosis system 1 according to the example embodiment is a system that may aid an imaging diagnosis by using an ultrasound image, an x-ray image, or the like. Hereinafter, for the convenience of description, the imaging diagnosis system 1 according to the example embodiment will be described as using an ultrasound image. However, it will be understood by those of ordinary skill in the art that the example embodiment is not limited to an ultrasound image.

The image capturing unit 10 that may capture an ultrasound image of a part of a patient's body may include a probe. The probe may include an ultrasonic transducer that 1) converts an electric signal into an ultrasound signal and 2) converts an ultrasound signal reflected from a patient into an electric signal. The probe may also capture an ultrasound image while in contact with a patient's body. A detailed description of the image capturing unit 10 with the probe is omitted since capturing an ultrasound image using the probe is obvious to those of ordinary skill in the art. Also, as described above, the example embodiment is not limited to an ultrasound image, and for example, the image capturing unit 10 may correspond to a radiologic device for capturing an x-ray image or the like.

The imaging diagnosis aiding apparatus 11 may 1) analyze an ultrasound image of a patient captured by the image capturing unit 10 and accordingly may generate a diagnostic image of the patient, which may be provided to a doctor, and 2) aid in an imaging diagnosis of the patient.

In general, a computer aided diagnosis (CAD) system may aid a doctor in an imaging diagnosis by 1) identifying a lesion (for example, a tumor) within a medical image by determining, via a computer, a presence of an abnormality, a size of an abnormality, a location of an abnormality, or the like and 2) giving a doctor a result of the identification. The CAD system may automatically detect potential lesions by identifying abnormal shadows. In order to identify an abnormal shadow, an abnormal lump shadow, a high-density micro-calcific shadow, or the like, which may represent a tumor or the like, may be detected by applying various image analysis parameters to a medical image.

The imaging diagnosis aiding apparatus 11 according to the example embodiment may correspond to an apparatus for performing CAD but may operate differently from a general method of performing CAD. Functions and operations of the imaging diagnosis aiding apparatus 11 according to the example embodiment will be described later.

The EMR database 12 may store medical records of at least one patient. The EMR database 12 may be located inside the imaging diagnosis aiding apparatus 11, or The EMR database 12 may be located outside the imaging diagnosis aiding apparatus 11 and communicate with the imaging diagnosis aiding apparatus 11 over a network. In other words, it will be understood by those of ordinary skill in the art that the EMR database 12 is not limited to any one configuration.

The user interface unit 13 may include an input device, such as a keyboard, a mouse, or the like, through which a doctor or a patient may input information regarding the patient's physical state or the like, and a display device for displaying a diagnostic image generated by the imaging diagnosis aiding apparatus 11 for a doctor or a patient to review. In other words, the user interface unit 13 may provide an interface for a doctor or a patient.

Before the imaging diagnosis aiding apparatus 11 begins to operate, at least one image analysis mode of the image analysis modes to be described may be selected via the user interface unit 13 by a system operator, such as a doctor. After the selection is input, the imaging diagnosis aiding apparatus 11 may analyze an ultrasound image in response to the at least one selected image analysis mode. However, selecting an image analysis mode may be omitted based on a use environment.

The EMR database 12 and the user interface unit 13 will be described later in more detail with reference to their functions and operations.

FIG. 2 is a detailed diagram illustrating the imaging diagnosis aiding apparatus 11 according to an example embodiment. Referring to FIG. 2, the imaging diagnosis aiding apparatus 11 includes a data reception unit 110, an EMR acquisition unit 120, an image analysis unit 130, a diagnostic image generation unit 140, and a display control unit 150. The imaging diagnosis aiding apparatus 11 shown in FIG. 2 may include one or more processors. The one or more processors may be implemented by an array of logic gates or a combination of a general-use microprocessor and a memory storing a program executable by the microprocessor. Furthermore, it will be understood by those of ordinary skill in the art that the imaging diagnosis aiding apparatus 11 may be implemented by another form of hardware.

In general, an optimized diagnostic ultrasound image clearly showing a part of a patient's body to be examined allows an imaging diagnosis system to accurately perform ultrasound imaging diagnosis based on ultrasound imaging. Accordingly, a system operator, such as a doctor, may select a probe suitable for a patient's state and a body part thereof to be examined. In general, the displayed ultrasound image may be subjected to fine adjustment with respect to various parameters for image analysis, such as brightness, resolution, contrast, and the like. In general, the fine adjustment of the parameters for image analysis may be performed by manual operation by a system operator, instead of being automatically performed.

In a general imaging diagnosis system using an ultrasound image, acquisition of an optimized diagnostic image suitable for a patient's state may be greatly affected by personal skills of a system operator, such as a doctor. The experience and proficiency of the system operator in device manipulation affects the image diagnosis. However, because a system operator may examine more than one patient daily and may perform an imaging diagnosis for each patient, complicated parameter adjustment may cause a great deal of work fatigue and increase the time for performing a diagnosis. Furthermore, an imaging diagnosis may be performed using similar parameters for almost every patient without considering a personal condition of the patient. Accordingly, a failure to acquire an optimized diagnostic image for an individual patient may result. An erroneous diagnosis may occur if a state of a patient is misjudged and/or a less than optimal image is acquired. Therefore, an ultrasound diagnostic image optimized for a health state of a patient may be acquired in response to characteristics of an individual patient, such as a physical state of a patient.

By acquiring an EMR of a patient of interest or an EMR of a patient who had a similar health state to a health state of the patient of interest from EMRs stored in the EMR database 12, the image diagnosis aiding apparatus 11 according to the example embodiment may analyze an ultrasound image on the basis of an image analysis profile included in the EMR acquired. For example, the image analysis profile may be filters, parameters, algorithms, or the like used in image analysis. The image diagnosis aiding apparatus 11 may acquire a diagnostic image suitable for the health state of the patient of interest to aid a doctor in a diagnosis.

The data reception unit 110 may receive a medical image and a current EMR of a patient. The medical image received by the data reception unit 110 may be a medical image captured by the image capturing unit 10 and may correspond to an ultrasound image as described above. Furthermore, the medical image may correspond to an ultrasound image showing a part of the patient's body, for example, breast tissue of the patient. Also, the current EMR received by the data reception unit 110 may contain information obtained by a doctor's examination of the patient, such as age, gender, physical information, health state, or the like of the patient, and may represent a medical record input through the user interface unit 13 of FIG. 1.

The EMR acquisition unit 120 may acquire image analysis profiles respectively used in a plurality of different image analysis modes from EMRs corresponding to the received current EMR among the EMRs stored in the EMR database 12.

The image analysis modes according to the example embodiment may include three modes. More specifically, mode 1 may analyze the received medical image in response to a past EMR of the patient. Mode 2 may analyze the received medical image in response to an EMR of a patient group having a field similar to at least one field of the received current EMR. Mode 3 may analyze a received medical image in response to an EMR having a similarity falling within a predetermined range with respect to the received current EMR. However, the image analysis modes herein described, are merely examples, and it will be understood by those of ordinary skill in the art that that image analysis modes having different characteristics from the above modes may be included.

The EMRs corresponding to the current EMR refer to EMRs coinciding with filtering rules set by the image analysis modes, among EMRs of the patient and of other patients. In this regard, mode 1 to mode 3 each may have different filtering rules.

More specifically, mode 1 may have a rule that filters the past EMR of the patient, mode 2 may have a rule that filters an EMR of a patient group having a field similar to at least one field of the received current EMR, and mode 3 may have a rule that filters an EMR having a similarity falling within a predetermined range with respect to the received current EMR.

The image analysis profiles respectively used in the image analysis modes may be different from each other because different EMRs coincide with different filtering rules.

The EMRs stored in the EMR database 12 may include information regarding a lesion, having a size of a previously measured lesion, a type of a lesion, a location of a lesion, or the like, as well as information regarding an image processing technique used in an image analysis to detect a lesion, information regarding a lesion segmentation technique, and information regarding a lesion classification technique. Different patients may have different health states, and ultrasound images thereof may be subjected to different analysis processes. Therefore, image analysis profiles included in the EMRs stored in the EMR database 12 may be different from each other.

In addition, the EMRs stored in the EMR database 12 may be clustered into groups of EMRs having similar fields in advance in response to a known data mining technique, and a search index with respect to a similarity between the EMRs is predefined.

The EMR acquisition unit 120 may then acquire an image analysis profile included in an EMR corresponding to the current EMR by referring to the clustered EMRs and the predefined search index.

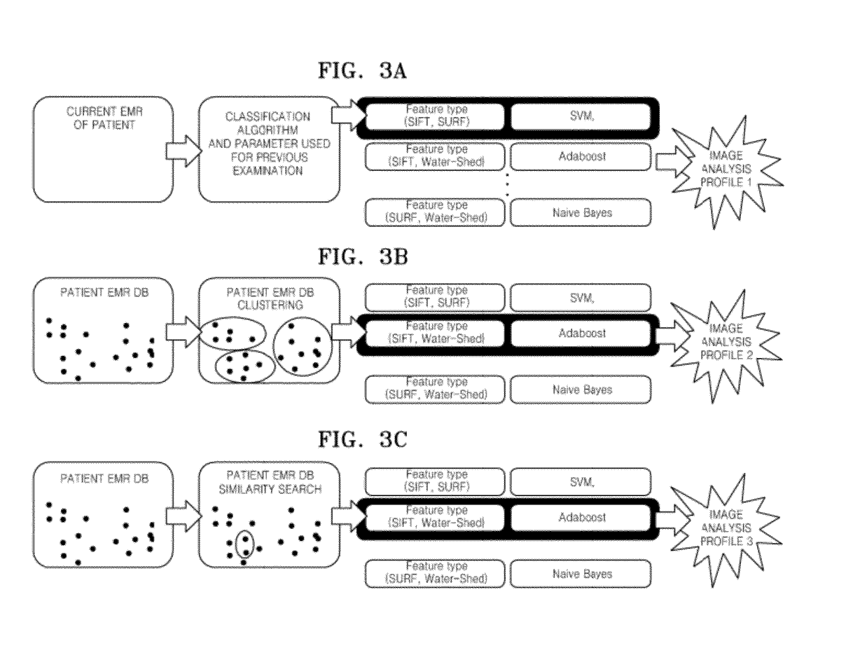

FIGS. 3A through 3C are views illustrating a process of acquiring image analysis profiles used in respective image analysis modes according to an example embodiment.

Referring to FIG. 3A, a past EMR of a patient may be retrieved and filtered from the EMRs stored in the EMR database 12 when in mode 1, and an image analysis profile included in the filtered EMR may also be retrieved.

Referring to FIG. 3B, an EMR of a patient group having a field similar to at least one field of the current EMR may be retrieved and filtered from the EMRs stored in the EMR database 12 when in mode 2, and an image analysis profile included in the filtered EMR may also be retrieved.

Referring to FIG. 3C, an EMR having a similarity that falls within a predetermined range with respect to the current EMR may be retrieved and filtered from the EMRs stored in the EMR database 12 when in mode 3, and an image analysis profile included in the filtered EMR may also be retrieved.

Referring to FIGS. 3A through 3C, different image analysis profiles may be acquired in the image analysis modes; however, there may be cases where the same image analysis profile may be acquired in two or more of the image analysis modes. It will be understood by those of ordinary skill in the art that, as is well known in the art, various kinds of parameters and algorithms may be included in the image analysis profiles and the image analysis profiles may not be limited to those illustrated in FIGS. 3A through 3C.

Referring back to FIG. 2, the image analysis unit 130 may analyze the received medical image according to each of the image analysis modes by using the acquired image analysis profiles. In this case, the image analysis unit 130 may analyze the received medical image by executing the image analysis modes in parallel.

More specifically, generally, in a process of analyzing an ultrasound image, the ultrasound image is first processed using an image processing filter and parameter. Subsequently, a region of interest (ROI) is extracted through an ROI segmentation using a segmentation algorithm and parameter. Features of the ROI may then be classified as a benign lesion or a malignant lesion using a classification algorithm and parameter. The ultrasound image may be analyzed through the above processes, and the analysis processes may be performed automatically by a computer.

According to the example embodiment, mode 1 may analyze a medical image by using the image analysis profile depicted in FIG. 3A, mode 2 may analyze the medical image by using the image analysis profile depicted in FIG. 3B, and mode 3 may analyze the medical image by using the image analysis profile depicted in FIG. 3C. In other words, a single medical image may be analyzed by independently applying different image analysis profiles corresponding to the various image analysis modes to the medical image.

Since a method of individually analyzing a medical image in the image analysis unit 130 by using known filters, parameters, and algorithms as described above is obvious to those of ordinary skill in the art, a detailed description of the method is omitted.

The diagnostic image generation unit 140 may generate a plurality of diagnostic images respectively corresponding to the image analysis modes on the basis of the analyzed medical image. Namely, the diagnostic image generation unit 140 may generate diagnostic images generated according to a result of the analysis conducted in mode 1, mode 2, and mode 3.

Accordingly, a variety of diagnostic images may be generated on the basis of the medical image analyzed by different references by different methods. Therefore, a system operator such as a doctor may be provided with a plurality of diagnostic images analyzed under various conditions.

The display control unit 150 may control display of the generated diagnostic images on a screen of the user interface unit 13 of FIG. 1. Furthermore, the display control unit 150 may control display of explanations on the image analysis modes respectively corresponding to the displayed diagnostic images.

According to this embodiment, a system operator may control display of the plurality of diagnostic images and may enlarge any one of the diagnostic images by manipulating a menu of the user interface unit 13 of FIG. 1, and may control display of the plurality of diagnostic images in an overlapped manner. Namely, the system operator may change a display environment of the diagnostic images using the user interface unit 13 of FIG. 1.

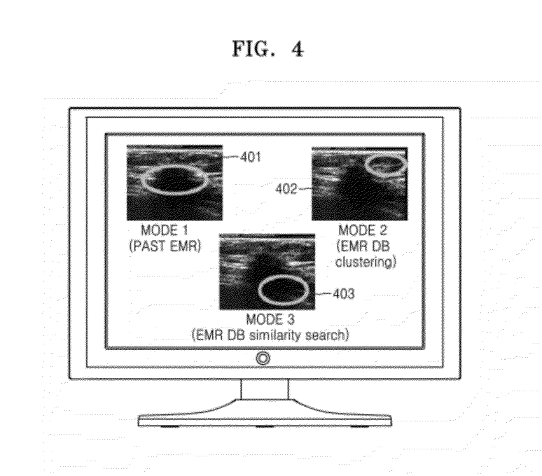

FIG. 4 is a view illustrating a plurality of diagnostic images displayed on the user interface unit 13 according to an embodiment of the present invention. Referring to FIG. 4, a diagnostic image 401 may be generated according to mode 1, a diagnostic image 402 may be generated according to mode 2, and a diagnostic image 403 may be generated according to mode 3 are displayed on a single screen provided on the user interface unit 13. Contents for identifying the image analysis modes respectively corresponding to the diagnostic images 401, 402, and 403 and an explanation regarding the image analysis modes are also displayed thereon.

A system operator, such as a doctor or the like, may select a diagnostic image, most appropriately showing a lesion, from among the diagnostic images generated under various conditions, and may examine the patient using the selected diagnostic image. Accordingly, a doctor may accurately and efficiently perform an imaging diagnosis of an ultrasonic image.

Referring back to FIG. 2, an update unit 160 may update the current EMR of the patient stored in the EMR database 12 with information regarding a diagnostic image determined to provide a system operator with an accurate analysis of the patient from among the displayed diagnostic images. In this case, the user interface unit 13 may receive an input from the system operator to select the determined diagnostic image, and the update unit 160 updates the EMR database 12 with information regarding the selected diagnostic image.

As described above, according to the imaging diagnosis system 1 of FIG. 1, in particular, the imaging diagnosis aiding apparatus 11 of FIG. 2 according to the example embodiment, an ultrasound image of a patient is analyzed by referring to an EMR stored in the EMR database 12, and diagnostic images for a plurality of diagnosis methods may be displayed, thereby aiding a system operator such as a doctor to accurately diagnose a disease.

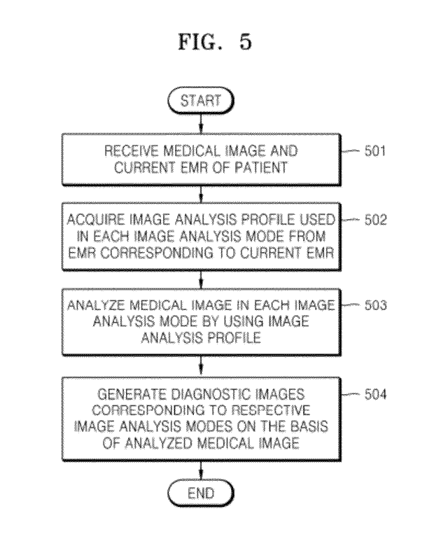

FIG. 5 is a flowchart illustrating a method of aiding an imaging diagnosis according to an example embodiment of the present invention. Referring to FIG. 5, the method of aiding an imaging diagnosis according to the example embodiment includes operations processed in a time-series manner in the imaging diagnosis aiding apparatus 11 shown in FIGS. 1 and 2. Thus, the contents of the above disclosure regarding the imaging diagnosis aiding apparatus 11, though omitted in the following description, may be applied to the method of aiding an imaging diagnosis according to the example embodiment.

In operation 501, the data reception unit 110 may receive a medical image and a current EMR of a patient.

In operation 502, the electronic medical record acquisition unit 120 may acquire image analysis profiles used in a plurality of different image analysis modes from EMRs stored in an EMR database corresponding to the received current EMR.

In operation 503, the image analysis unit 130 may analyze the received medical image according to each of the image analysis modes by using the acquired image analysis profiles.

In operation 504, the diagnostic image generation unit 140 may generate a plurality of diagnostic images respectively corresponding to the image analysis modes on the basis of the analyzed medical image.

As described above, according to the one or more of the above embodiments of the present invention, an EMR of a patient of interest or an EMR of a patient who had a health state similar to the health state of the patient of interest is acquired from EMRs stored in an EMR database, and an ultrasound image may be analyzed according to the EMR acquired, so that a doctor can perform a diagnosis using a diagnostic image that is most suitable to the health state of the patient of interest. Furthermore, a doctor may select a diagnostic image most appropriately showing a lesion among diagnostic images generated under various conditions and examine the patient of interest according to the selected diagnostic image, thereby accurately and efficiently performing an imaging diagnosis of an ultrasound image on the patient of interest.

The processes, functions, methods and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and computer-readable codes or program instructions may be stored and executed in a decentralized manner. A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of aiding an imaging diagnosis, the method comprising:
receiving a medical image and a current electronic medical record (EMR) of a patient;
acquiring image analysis profiles used in a plurality of different image analysis modes from EMRs corresponding to the received current EMR among EMRs stored in an EMR database;
analyzing the received medical image according to each of the image analysis modes by using the acquired image analysis profiles; and
generating a plurality of diagnostic images respectively corresponding to the image analysis modes on the basis of the analyzed medical image.

2. The method of claim 1, wherein the corresponding EMRs are EMRs coinciding with filtering rules of the image analysis modes among EMRs of the patient and of another patient.

3. The method of claim 2, wherein the filtering rule comprises at least one selected from a group including a rule that filters a past EMR of the patient, a rule that filters an EMR of a group having a field similar to at least one of fields of the received current EMR, and a rule that filters an EMR having a similarity falling within a predetermined range with respect to the received current EMR.

4. The method of claim 1, further comprising controlling display of the generated diagnostic images on a screen provided on a user interface unit.

5. The method of claim 4, wherein the controlling of the display comprises displaying explanations on the image analysis modes respectively corresponding to the displayed diagnostic images.

6. The method of claim 4, further comprising updating the current EMR of the patient stored in the EMR database with information regarding a diagnostic image determined to provide a user with an accurate analysis of the patient among the displayed diagnostic images.

7. The method of claim 1, wherein the EMRs stored in the EMR database are clustered in advance into groups of EMRs having similar fields by a data mining technique, and a search index with respect to a similarity between the EMRs is predefined.

8. The method of claim 1, wherein the analyzing of the received medical image includes executing the image analysis modes in parallel.

9. The method of claim 1, further comprising, before the acquiring of the image analysis profiles, receiving an input selecting at least one image analysis mode desired by a user among the image analysis modes from a user interface unit,
wherein the acquiring of the image analysis profiles and the analyzing of the received medical image are performed only for the at least one selected image analysis mode.

10. The method of claim 1, wherein the image analysis profiles comprise information regarding an image processing technique, information regarding a lesion segmentation technique, and information regarding a lesion classification technique.

11. The method of claim 1, wherein the medical image is an ultrasound image of a part of the patient's body.

12. A non-transitory computer-readable storage medium storing a program for executing the method of claim 1 in a computer.

13. An apparatus for aiding an imaging diagnosis, comprising:
a data reception unit configured to receive a medical image and a current electronic medical record (EMR) of a patient;
an EMR acquisition unit configured to acquire image analysis profiles used in a plurality of different image analysis modes from EMRs corresponding to the received current EMR among EMRs stored in an EMR database;
an image analysis unit configured to analyze the received medical image according to each of the image analysis modes by using the acquired image acquisition profiles; and
a diagnostic image generation unit configured to generate a plurality of diagnostic images respectively corresponding to the image analysis modes on the basis of the analyzed medical image.

14. The apparatus of claim 13, wherein the corresponding EMRs are EMRs coinciding with filtering rules of the image analysis modes among EMRs of the patient and of another patient.

15. The apparatus of claim 14, wherein the filtering rule comprises at least one selected from the group consisting of a rule that filters a past EMR of the patient, a rule that filters an EMR of a group having a field similar to at least one of fields of the received current EMR, and a rule that filters an EMR having a similarity falling within a predetermined range with respect to the received current EMR.

16. The apparatus of claim 13, further comprising a display control unit configured to control display of the generated diagnostic images on a screen provided on a user interface unit connected to the apparatus for aiding an imaging diagnosis.

17. The apparatus of claim 13, wherein the EMRs stored in the EMR database are clustered in advance into groups of EMRs having similar fields by a data mining technique, and a search index with respect to a similarity between the EMRs is predefined.

18. An imaging diagnosis system comprising:
an image capturing unit configured to capture a medical image of a part of a patient's body;
an electronic medical record (EMR) database configured to store EMRs of the patient and of another patient;
an apparatus for aiding an imaging diagnosis, the apparatus configured to receive the medical image and a current electronic medical record (EMR) of the patient, configured to acquire image analysis profiles used in plurality of different image analysis modes from EMRs corresponding to the received current EMR among the EMRs stored in the EMR database, configured to analyze the received medical image according to each of the image analysis modes by using the acquired image acquisition profiles, and configured to generate a plurality of diagnostic images respectively corresponding to the image analysis modes on the basis of the analyzed medical image; and
a user interface unit configured to display the generated diagnostic images on a screen of the user interface.

19. The imaging diagnosis system of claim 18, wherein the corresponding EMRs are EMRs coinciding with filtering rules of the image analysis modes among the EMRs of the patient and of the other patient.

20. The imaging diagnosis system of claim 18, wherein the EMRs stored in the EMR database are clustered in advance into groups of EMRs having similar fields by a data mining technique, and a search index with respect to a similarity between the EMRs is predefined.

21. A method of aiding an imaging diagnosis of a lesion, the method comprising:
receiving a medical image of the lesion and a current electronic medical record (EMR) of a patient;
acquiring image analysis profiles used in a plurality of different image analysis modes from EMRs corresponding to the received current EMR among EMRs stored in an EMR database, wherein the EMRs include any of a size, a type and a location of previously measured lesions;
analyzing the received medical image according to each of the image analysis modes by using the acquired image analysis profiles based on the any of the size, the type and the location of the previously measured lesions; and
generating a plurality of diagnostic images respectively corresponding to the image analysis modes on the basis of the analyzed medical image.
